(19) United States
(12) Patent Application Publication
(10) Pub. No.: US 2024/0426687 A1
(43) Pub. Date: Dec. 26, 2024

(54) FIXING APPARATUS FOR USE WITH INDUSTRIAL ROBOT AND METHOD OF MEASURING BACKLASH OF GEAR

(71) Applicant: ABB SCHWEIZ AG, Baden (CH)

(72) Inventors: Hao Gu, Shanghai (CN); Yongkang Zhang, Shanghai (CN); Yin Tian, Shanghai (CN)

(21) Appl. No.: 18/820,506

(22) Filed: Aug. 30, 2024

Related U.S. Application Data
(63) Continuation of application No. PCT/CN2022/081775, filed on Mar. 18, 2022.

(51) Int. Cl. G01L 5/00; B25J 19/02

(52) U.S. Cl. CPC G01L 5/0061; B25J 19/02

(57) ABSTRACT

A fixing apparatus for use with an industrial robot and a method of measuring a backlash of a gear. The industrial robot includes a first arm and a second arm connected to the first arm. The fixing apparatus includes a first securing component configured to couple to the first arm and a second securing component configured to couple to the second arm. When the first securing component is coupled to the first arm and the second securing component is coupled to the second arm, at least one of the first arm and the second arm is remained at a non-gravity position.

### FIELD

Example embodiments of the present disclosure generally relate to the field of industrial robot, and more particularly, to a fixing apparatus for use with an industrial robot and a method of measuring a backlash of a gear.

### BACKGROUND

In the system structure of industrial robot, the mechanical arms of the industrial robot are driven by power sources such as servo motor and corresponding gears. Although the gear is proved in practice to have the highest transmission, there is also a problem, that is, the clearance of gear. Since the gear clearance represents the performance of the accuracy of gear, regular inspection and testing in order to find faults and analyze the causes in time are particularly critical. Therefore, how to monitor the performance of the industrial robot in real time remains a challenge.

### SUMMARY

In general, example embodiments of the present disclosure provide a fixing apparatus for use with an industrial robot to assist in measuring a backlash of a gear.

In a first aspect, there is provided a fixing apparatus for use with an industrial robot. The industrial robot comprising a first arm and a second arm connected to the first arm. The fixing apparatus comprises a first securing component configured to couple to the first arm; and a second securing component configured to couple to the second arm, wherein when the first securing component is coupled to the first arm and the second securing component is coupled to the second arm, the first arm is remained at a non-gravity position.

According to example embodiments, the machining is convenient for and brings about cost reduction while ensuring the function at the same time. Also, the fixing apparatus can be used for measuring the backlash of the gear automatically without human intervention, thereby improving the efficiency of the measuring.

In some example embodiments, the first securing component comprises a first ring to encircle the first arm and the second securing component comprises a second ring to encircle the second arm. With these embodiments, the first arm and the second arm can be kept stationary with each other to ensure precise test result.

In some example embodiments, the fixing apparatus is adapted to fix the first arm and the second arm which are positioned at a different pose. With these embodiments, the usage scope of the present disclosure can be enlarged.

In some example embodiments, the first securing component comprises a first plate to couple to the first arm and the second securing component comprises a second plate to couple to the second arm. With these embodiments, the installation is simple and convenient, which fundamentally solves the problem of complex test environment in the conventional test method.

In some example embodiments, the fixing apparatus is adapted to fix the first arm and the second arm which are positioned in parallel to each other. With these embodiments, the usage scope of the present disclosure can be enlarged.

In some example embodiments, the first arm and the second arm are hinged via a joint, and wherein the centroid of the joint and the centroid of the at least one of the first arm and the second arm form a plumbline parallel to a non-gravity direction. With these embodiments, the result can be accurate without the influence of extra gravitational moment.

In a second aspect, there is provided a method of measuring a backlash of a gear. The gear is coupled between an input shaft and an output shaft, the input shaft being coupled to a motor. The method comprising: securing the output shaft by means of the fixing apparatus; causing the motor to provide a torque for the input shaft to allow the gear to rotate by a degree under the torque; and obtaining the torque and rotated degree of the gear; and determining the backlash of the gear based on the torque and the rotated degree. With these embodiments, this process reduces the cost of manpower and materials, reduces errors and improves the test frequency and utilization.

In some example embodiments, the securing the output shaft is achieved by the fixing apparatus of the first aspect.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a backlash in a transmission gear;

FIG. 2 illustrates a principle of measuring the backlash of a gear according to a traditional method;

FIG. 3 illustrates an example hysteretic curve;

FIG. 4 illustrates a principle of measuring the backlash of a gear according to the present disclosure;

FIG. 5 illustrates a schematic view of an industrial robot in accordance with an example embodiment of the present disclosure;

FIG. 6 illustrates a schematic view of the fixing apparatus for use with the industrial robot of FIG. 5;

FIG. 7 illustrates a schematic view of an industrial robot in accordance with another example embodiment of the present disclosure;

FIG. 8 illustrates a schematic view of the fixing apparatus for use with the industrial robot of FIG. 7; and

FIG. 9 illustrates a method of measuring a backlash of a gear according to the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As mentioned above, the backlash of a gear should be monitored in real time to ensure the performance of the corresponding industrial robot. The detail of the present disclosure will be described afterwards.

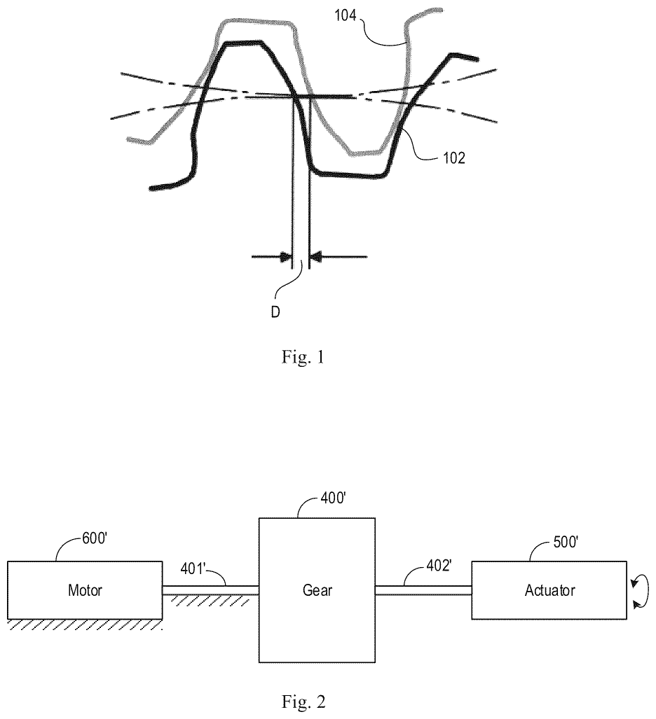

FIG. 1 illustrates a backlash in a transmission gear. The backlash, which is indicated by D, exists between two gears 102, 104. The gear 102 may be coupled to an input device (not shown) and the gear 104 may be coupled to an output device (not shown). In such a situation, the gear 102 operates as a driving gear while the gear 104 operates as a driven gear.

The backlash D can be incurred by many factors, for example, a gear wear. The gear wear of any of the gears 102, 104 will reduce transmission accuracy thereof, which causes inaccurate transmission and reduces the service life of the gears 102, 104. If the clearance between the gears 102, 104 is too large, the thickness of the gear teeth will be too small, which will affect the strength. Especially for the gear transmission system that needs to realize forward and reverse rotation, the improper backlash D will have a great impact during speed change. It is easy to cause tooth breakage and other failures. The large meshing clearance may be due to processing or design problems. If there are no problems in part design and processing, the large meshing clearance is probably due to large center distance error, in this case, the meshing of gears is not a normal state, which results in increased wear, reduced coincidence coefficient and reduced motion transmission accuracy.

Therefore, how to accurately measure the backlash of the gears is a key point to monitor the performance of the gears in real time.

Conventionally, many approaches are presented to measure the backlash of the gear. FIG. 2 illustrates a principle of measuring the backlash of a gear according to a traditional method. As can be seen in FIG. 2, the gear 400′ is couple to a motor 600′ by an input shaft 401′ and coupled to an actuator 500′ by an output shaft 402′. The actuator 500′ may be a mechanical arm of an industrial robot.

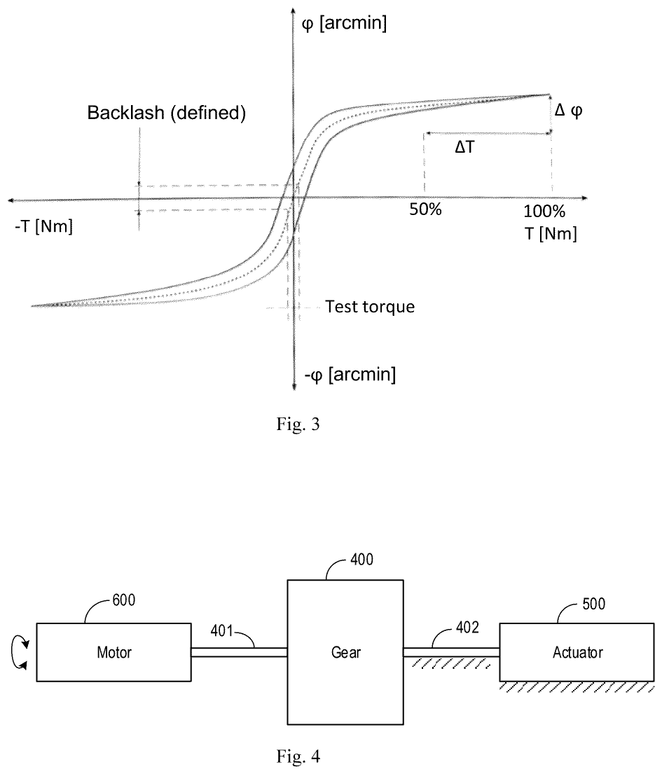

As shown, the traditional measurement method is to first fix the input end of the gear 400′. The input end includes the motor 600′ and the input shaft 401′. Afterwards, a force is continuously applied to a torque meter in both rotation directions of the output end of the gear 400′ to overcome the friction in the gearbox, and then unload gradually. The output end includes the actuator 500′ and the output shaft 402′. In the whole process, the input end of the gear 400′ will move at a small angle, which is called return clearance. A device is used to record the angular profile over the torque. A closed curve is obtained which is called a hysteretic curve. FIG. 3 illustrates an example hysteretic curve. The hysteretic curve can directly reflect the relationship between the force and displacement between teeth of the gear 400′, which is regarded as a load displacement curve. In the curve, it can be determined how much displacement is generated between teeth under the action of a certain force.

In a word, the traditional gear clearance measurement method is to fix the motor 600′ and the input shaft 401′, apply torque to the output end and calculate the backlash value. However, many disadvantages may be obvious.

For example, it is necessary to manually build a test environment for each robot axis. Therefore, many complex equipment have to be involved including force sensor, displacement sensor and data acquisition card. Moreover, in the process of frequent disassembly and assembly of test equipment, an installation error may be caused, thus affecting the test accuracy. Worse still, applying torque to the output end is operated manually. This means the magnitude of the torque is not under a precise control. This is probably taking risk of damaging parts.

In order to at least address the above mentioned drawbacks, a new method of measuring the backlash and a corresponding fixing apparatus is proposed in the present disclosure. In order to solve the limitations of the current gear clearance test method, the invention adopts a new integrated automatic technical test solution, adopts a kind of contrary design idea compared with the traditional method.

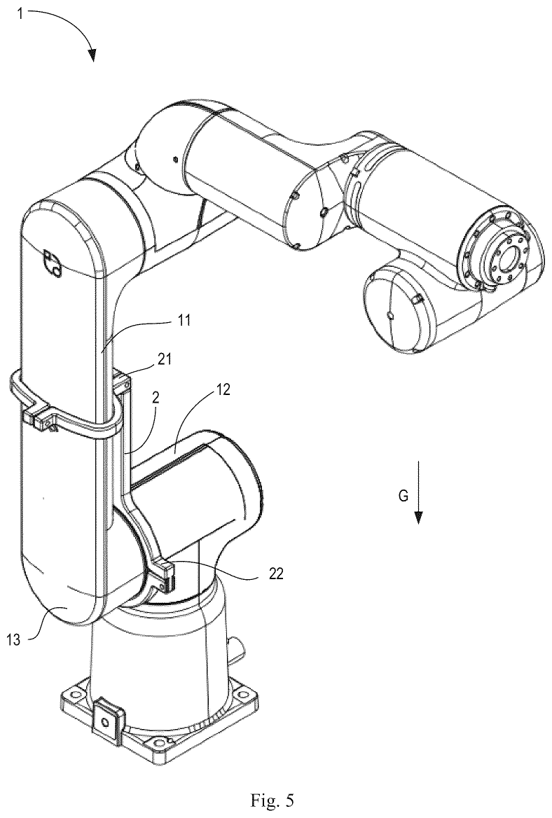

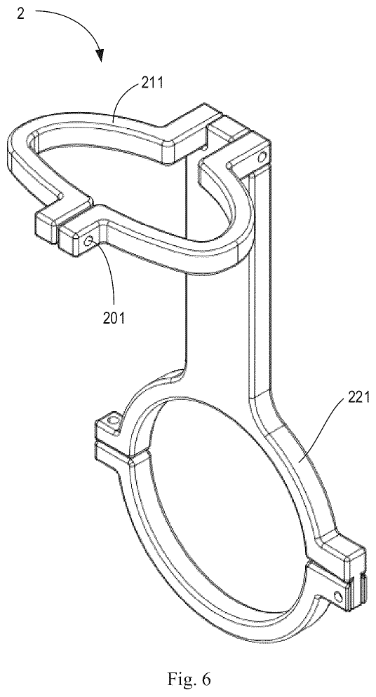

Example embodiments will be described in more detail hereinafter with reference to FIGS. 4-9.

FIG. 4 illustrates a principle of measuring the backlash of a gear according to the present disclosure. As can be seen from FIG. 4, the gear 400 is couple to a motor 600 by an input shaft 401 and coupled to an actuator 500 by an output shaft 402. Contrary to the traditional method, the present invention takes the fixed output end as the standard; the input end is applied with the specified torque by the motor. The input end includes the motor 600 and the input shaft 401, and the output end includes the actuator 500 and the output shaft 402. The actuator 500 may be a mechanical arm of an industrial robot. By fixing the actuator 500 and the output shaft 402 while causing the motor 600 and the input shaft 401 to rotate, the system does not need the participation of any external measuring equipment, such as the torque meter and displacement sensor used in the traditional methods. Instead, during the measurement, the motor 600 operates as the input and a signal inside the robot controller can be collected to obtain the angular displacement and torque in real time.

FIG. 5 illustrates a schematic view of an industrial robot 1 in accordance with an example embodiment of the present disclosure. As shown, the industrial robot 1 generally comprises a first arm 11 and a second arm 12 connected to each other via a joint 13. A gear may be provided within the joint 13. As discussed above, in order to measure the backlash of the gear within the joint 13, a fixing apparatus 2 may be provided for use with the industrial robot 1.

FIG. 6 illustrates a schematic view of the fixing apparatus 2 for use with the industrial robot 1. As shown, the fixing apparatus 2 generally comprises a first securing component 21 and a second securing component 22. The first securing component 21 is used to couple to the first arm 11 while the second securing component 22 is used to couple to the second arm 12. The fixing apparatus 2 is configured to enable the first arm 11 to be remained at a non-gravity position when the first securing component 21 is coupled to the first arm 11 and the second securing component 22 is coupled to the second arm 12. In other example embodiments, both the first arm 11 and the second arm 12 can be remained at non-gravity positions.

According to example embodiments, with the help of the fixing apparatus 2, the relative movement between the first arm 11 and the second arm 12 is inhibited. In this way, for the gear within the joint 13 connecting the first arm 11 and the second arm 12, the fixing apparatus 2 provides a situation where the output end of the gear can be kept stationary. In such a circumstance, a motor 600 may apply a specified torque to measure the backlash of the gear, which has been discussed above.

Moreover, in the example embodiment shown in FIG. 5, the first arm 11 is fixed at a non-gravity position. This means that the imaginary line connecting the centroid of the first arm 11 and the centroid of the joint 13 is parallel to the plumbline parallel to a non-gravity direction G. With these embodiments, no extra gravitational moment would be exerted onto the gear to be measured. Therefore, the measuring result can be more accurate.

It is to be understood that even though the fixing apparatus 2 in FIG. 5 is shown to be located in a vertical position, this is merely illustrative, rather than restrictive. According to the specific orientations of the first arm 11 and the second arm 12, the fixing apparatus 2 can be rotated in suitable angle to adapt to the first arm 11 and the second arm 12 with various poses.

Now referring to FIG. 6, in the illustrated embodiments, the first securing component 21 comprises a first ring 211 to encircle the first arm 11. The second securing component 22 comprises a second ring 221 to encircle the second arm 12. The shapes of the first and second rings 211, 221 are designed to match the cross-sections of the first and second arms 11, 12. A bolt 201 may be used to reinforce the connection of the fixing apparatus 2 and the first and second arms 11, 12. With these embodiments, the fixing apparatus 2 can be firmly coupled to the industrial robot 1, which helps improve the precision of the measuring result.

Referring back to FIG. 5, in the illustrated embodiments, the first arm 11 and the second arm 12 are positioned substantially perpendicular to each other. In other embodiments, the first arm 11 and the second arm 12 may be positioned at a different pose. Accordingly, the angle between the first and second rings 211, 221 can be adjusted to ensure firm connection between the fixing apparatus 2 and the industrial robot 1.

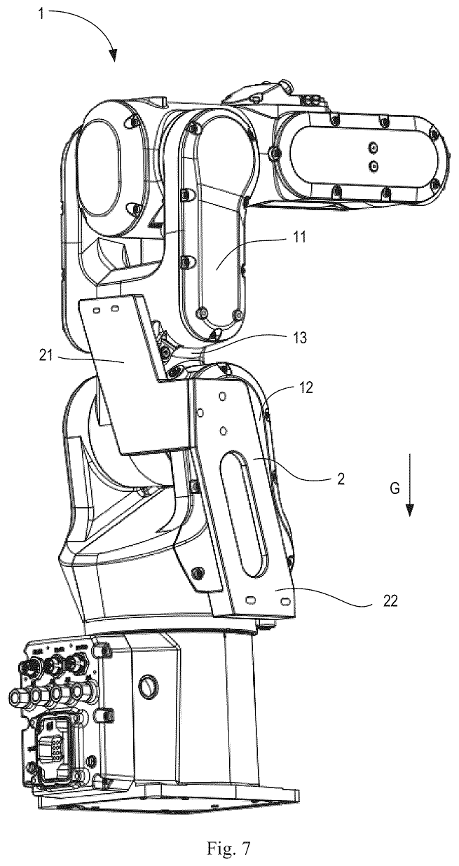

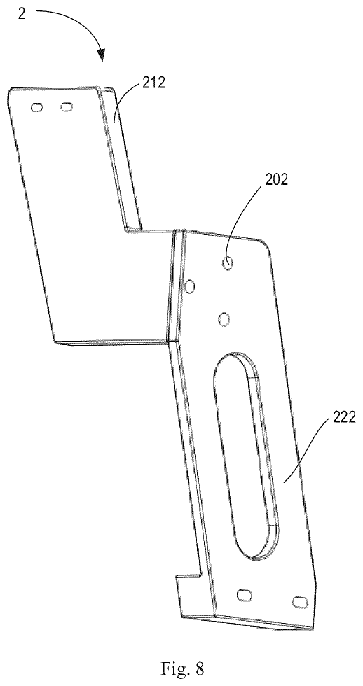

FIGS. 7-8 illustrate a schematic view of an industrial robot 1 and a corresponding fixing apparatus 2 in accordance with another example embodiment of the present disclosure.

Similar to the embodiments shown in FIG. 5-6, the industrial robot 1 as shown in FIG. 7 generally comprises a first arm 11 and a second arm 12 connected to each other via a joint 13. A gear may be provided within the joint 13. The fixing apparatus 2 is provided for use with the industrial robot 1, in order to measure the backlash of the gear within the joint 13. As shown, the first securing component 21 is used to couple to the first arm 11 while the second securing component 22 is used to couple to the second arm 12. The fixing apparatus 2 is configured to enable the first arm 11 to be remained at a non-gravity position. In other example embodiments, both the first arm 11 and the second arm 12 can be remained at non-gravity positions.

Unlike the embodiments shown in FIG. 5-6, the first securing component 21 as shown in FIGS. 7 & 8 comprises a first plate 212 to couple to the first arm 11 and the second securing component 22 comprises a second plate 222 to couple to the second arm 12. The fixing apparatus 2 is adapted to fix the first arm and the second arm 12 which are positioned in parallel to each other to ensure that both the first arm and the second arm 12 are remained at non-gravity positions. Different with the embodiments shown in FIG. 5-6, the first arm 11 and the second arm 12 may be positioned at a zero angle. This allows the measuring method of the present disclosure to be used in more scenarios. With these embodiments, no extra gravitational moment would be exerted onto the gear to be measured. Therefore, the measuring result can be more accurate.

As shown in FIG. 8, a through hole 202 may be provided at the fixing apparatus 2 to ensure stable connection with the industrial robot 1. In other embodiment, the fixing apparatus 2 may be made of aluminum to reduce weight as well as achieve simple and convenient installation. It should be understood that this is just one example, and the specific materials are not limited to embodiments of the present disclosure.

In a second aspect, there is provided a method of measuring a backlash of a gear 400. The gear 400 is coupled between an input shaft 401 and an output shaft 402, the input shaft 401 being coupled to a motor 600. The method comprising: securing the output shaft 402 by means of the fixing apparatus 2 discussed above; causing the motor 600 to provide a torque for the input shaft 401 to allow the gear 400 to rotate by a degree under the torque; and obtaining the torque and rotated degree of the gear 400; and determining the backlash of the gear 400 based on the torque and the rotated degree. In some further example embodiment, the above processes may be conducted several times to achieve the averaging value of the test result, which ensures the accuracy of the results.

According to example embodiments, the output end is fixed through the fixing apparatus 2, and the motor torque change can be used as the input end. In this situation, a controller software algorithm controls the motor rotation and collects, calculates, analyzes and processes the data in real time. The whole automatic process eliminates human errors, saves time and effort in building the test environment and the test process is simple and efficient. In this way, the measuring time is greatly shorted, the process is simplified, the measuring errors can be minimized, the test frequency and utilization can be improved, and the cost of manpower and materials can be reduced accordingly.

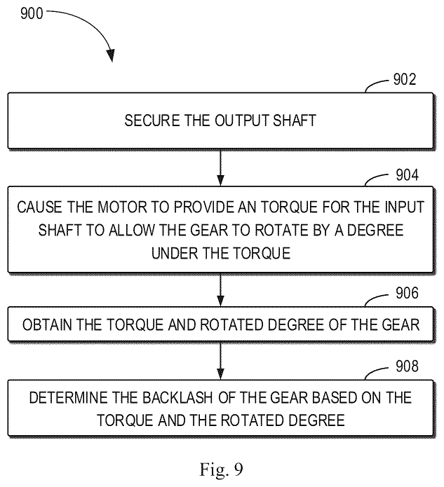

FIG. 9 illustrates a method 900 of measuring a backlash of a gear 400 according to the present disclosure. With reference to FIG. 4, the gear 400 is coupled between an input shaft 401 and an output shaft 402, the input shaft 401 being coupled to the motor 600 and the output shaft 402 is coupled to the actuator 500. At block 902, the output shaft 402 is secured. In some example embodiment, the securing can be achieved by means of the fixing apparatus 2 discussed above. At block 904, the motor 600 is caused to provide a torque for the input shaft 401 to allow the gear 400 to rotate by a degree under the torque. At block 906, the torque and rotated degree of the gear 400 are obtained. At block 908, the backlash of the gear 400 is determined based on the torque and the rotated degree.

In some example embodiments, the method 900 can be carried out by software algorithm of robot program design, and the whole processes, including torque loading, test execution, data acquisition, calculation and analysis report, do not need manual intervention. In this way, the test process is simple and efficient.

While operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A fixing apparatus for use with an industrial robot, the industrial robot comprising a first arm and a second arm connected to the first arm, the fixing apparatus comprising:
a first securing component configured to couple to the first arm; and
a second securing component configured to couple to the second arm,
wherein when the first securing component is coupled to the first arm and the second securing component is coupled to the second arm, the first arm is remained at a non-gravity position.

2. The fixing apparatus of claim 1, wherein the first securing component comprises a first ring to encircle the first arm and the second securing component comprises a second ring to encircle the second arm.

3. The fixing apparatus of claim 2, wherein the fixing apparatus is adapted to fix the first arm and the second arm which are positioned at a different pose.

4. The fixing apparatus of claim 1, wherein the first securing component comprises a first plate to couple to the first arm and the second securing component comprises a second plate to couple to the second arm.

5. The fixing apparatus of claim 4, wherein the fixing apparatus is adapted to fix the first arm and the second arm which are positioned in parallel to each other.

6. The fixing apparatus of claim 1, wherein the first arm and the second arm are hinged via a joint, and wherein the centroid of the joint and the centroid of the at least one of the first arm and the second arm form a plumbline parallel to a non-gravity direction.

7. A method of measuring a backlash of a gear, the gear being coupled between an input shaft and an output shaft, the input shaft being coupled to a motor and the output shaft being coupled to an actuator, the method comprising:
securing the output shaft;
causing the motor to provide a torque for the input shaft to allow the gear to rotate by a degree under the torque;
obtaining the torque and rotated degree of the gear; and
determining the backlash of the gear based on the torque and the rotated degree.

8. The method of claim 7, wherein securing the output shaft is achieved by a fixing apparatus
wherein the fixing apparatus comprises:
a first securing component configured to couple to a first arm of an industrial robot; and
a second securing component configured to couple to a second arm of the industrial robot.
wherein when the first securing component is coupled to the first arm and the second securing component is coupled to the second arm, the first arm is remained at a non-gravity position.

9. The method of claim 8, wherein the first securing component comprises a first ring to encircle the first arm and the second securing component comprises a second ring to encircle the second arm.

10. The method of claim 9, wherein the fixing apparatus is adapted to fix the first arm and the second arm which are positioned at a different pose.

11. The method of claim 8, wherein the first securing component comprises a first plate to couple to the first arm and the second securing component comprises a second plate to couple to the second arm.

12. The method of claim 11, wherein the fixing apparatus is adapted to fix the first arm and the second arm which are positioned in parallel to each other.

13. The method of claim 8, wherein the first arm and the second arm are hinged via a joint, and wherein the centroid of the joint and the centroid of the at least one of the first arm and the second arm form a plumbline parallel to a non-gravity direction.

14. The fixing apparatus of claim 2, wherein the first arm and the second arm are hinged via a joint, and wherein the centroid of the joint and the centroid of the at least one of the first arm and the second arm form a plumbline parallel to a non-gravity direction.

15. The fixing apparatus of claim 3, wherein the first arm and the second arm are hinged via a joint, and wherein the centroid of the joint and the centroid of the at least one of the first arm and the second arm form a plumbline parallel to a non-gravity direction.

16. The fixing apparatus of claim 4, wherein the first arm and the second arm are hinged via a joint, and wherein the centroid of the joint and the centroid of the at least one of the first arm and the second arm form a plumbline parallel to a non-gravity direction.

17. The fixing apparatus of claim 5, wherein the first arm and the second arm are hinged via a joint, and wherein the centroid of the joint and the centroid of the at least one of the first arm and the second arm form a plumbline parallel to a non-gravity direction.
